(19) United States
(12) Patent Application Publication
(10) Pub. No.: US 2020/0008907 A1
(43) Pub. Date: Jan. 9, 2020

(54) DENTAL RESTORATION METHOD

(71) Applicant: EUROTEKNIKA, Sallanches (FR)

(72) Inventors: Benjamin Calvat, Ugine (FR); Cédric Lancieux, Megève (FR)

(73) Assignee: EUROTEKNIKA, Sallanches (FR)

(21) Appl. No.: 16/493,398

(22) PCT Filed: Mar. 15, 2018
(86) PCT No.: PCT/EP2018/056509

§ 371 Date: Sep. 12, 2019

(30) Foreign Application Priority Data
Mar. 20, 2017 (FR) 1752258

(51) Int. Cl. A61C 8/00; A61C 13/00; A61C 9/00

(52) U.S. Cl. CPC A61C 8/008; A61C 8/0068; A61C 8/0001; A61C 13/0004; A61C 9/004; A61C 8/0069

(57) ABSTRACT

A dental restoration method comprising a step of determining a positioning of a dental implant (60), integrated into a bone structure (62) of an individual, from the identification and positioning of a one-piece healing member (10), attached at one of the ends of same in the implant (60), the healing element (10) comprising a side surface (13) intended to be integrated into a gum in order to shape the gum during the healing of same, and an end surface (14), a part of the side surface (13) and of the end surface (14) forming an emergent surface, intended to remain outside the gum, that is asymmetrical relative to at least a perpendicular median plane.

The present invention relates to a dental restoration method. The invention also relates to a method for producing a dental restoration abutment and/or a dental prosthesis, comprising the implementation of such a dental restoration method. The invention also relates to a healing element suitable for such a dental restoration method and such a method for production of a dental restoration abutment and/or a dental prosthesis.

Dental restoration makes it possible to produce a denture in a patient who has lost some or all of his or her teeth. It is based on integrating one or more implants in the bone structure and is performed by making an incision in the gum in order to reach and penetrate the bone structure. Thereafter, a healing element is generally secured to an implant, and this assembly remains untouched until such time as the implant has become incorporated in the bone structure by osseointegration and the gum has healed around the healing element. The dental restoration can be completed by fixing a restoration abutment to the implant, on which abutment the dental prosthesis is secured. The abutment and the dental prosthesis are individualized, adapted to the anatomy of the patient and to the tooth being replaced, in order to achieve a result that is as close as possible to the ideal natural dentition. For this purpose, the precise volume of the space to be restored is generally taken into account by taking an impression, which allows the individualized production of the dental prosthesis.

In the prior art, the existing methods of dental restoration come up against all or some of the following technical problems:
in many existing methods, a new intervention on the gum is performed after it has healed following the implant placement, in order to take the physical or digital impression of the space to be restored, while having a view of the implant and of the gum so as to take into consideration this overall geometry, in order to produce an abutment and a prosthesis of precise shapes: this approach does of course cause trauma;
other existing methods limit this trauma by using healing components which are not removed when taking an impression, so as not to damage the gum; however, these methods make use of particular healing elements, generally of a substantially cylindrical standard shape, sometimes incorporating indicators and/or several additional components in order to take account of all or some of the geometry above the implant without having total access thereto by taking an impression. These less traumatizing methods thus have other drawbacks of complexity and/or poorer optimization of the healing phase.

Thus, a general aim of the invention is to provide a dental restoration solution that avoids all or some of the drawbacks of the prior art.

More precisely, a first aim of the invention is to provide a dental restoration solution that minimizes the trauma caused to the patient during the restoration method.

A second aim of the invention is to provide a dental restoration solution that allows a restoration that is adapted as much as possible to the anatomy of the patient.

A third aim of the invention is to provide a dental restoration solution that is as simple as possible.

To this end, the invention relates to a dental restoration method, or a method for producing a dental restoration abutment, comprising a step of determining a positioning of a dental implant, integrated in a bone structure of an individual, from the identification and positioning of a one-piece healing element, fixed at one of its ends in the implant, the healing element comprising a side surface intended to be integrated within a gum in order to shape the gum during the healing of the latter, and an end surface, a part of the side surface and of the end surface forming an emergent surface which is intended to remain outside the gum and which is asymmetrical with respect to at least one perpendicular median plane.

The dental restoration method, or the method for producing a dental restoration abutment, can comprise a step of fixing the healing element on the implant, in particular a step of fixing by way of a screw that cooperates with a through-opening of the healing element and a threaded opening of the implant.

The healing element can comprise a conical bearing surface cooperating with a conical portion of a screw head in order to seal an interface between the screw and the healing element.

The healing element can comprise, at the opening, at least one thread cooperating with a threaded part of the screw in order to prevent separation of the screw and the healing element by a simple translational movement.

The healing element can comprise a frustoconical portion cooperating with a conical bearing surface of the implant in order to seal an interface between the implant and the healing element and to reduce to zero any translational play between the healing element and the implant.

The healing element can be produced from a polymer material, in particular from a PEEK material.

The healing element can be produced by machining and/or by molding and/or by addition of material.

The step of determining the positioning of the implant can comprise the following sub-steps:
taking a manual or digital impression of an oral space comprising the healing element fixed on the implant;
automatically detecting the positioning of the implant by identifying:
   the axis of the implant corresponding to an axis of the healing element identified by the geometry of its surface emergent from the gum or from an association with a healing element stored in a database, in particular from its reference input in a man-machine interface or from its automatic recognition by the shape of its emergent part and/or by manual input of the positioning of several points of the emergent surface on a graphic representation on a man-machine interface;
   the orientation of the implant from the orientation of the surface emergent from the gum or from an association with a healing element stored in a database, in particular from its reference input in a man-machine interface or from its automatic recognition by the shape of its emergent part and/or by manual input of the positioning of several points of the emergent surface on a graphic representation on a man-machine interface;
   the height of the implant by determining the height of the healing element, from a color or an indicator of its surface emergent from the gum or from an association with a healing element stored in a database, in particular from its reference input in a man-machine interface or from its automatic recognition by the shape of it emergent part and/or by manual input of the positioning of several points of the emergent surface on a graphic representation on a man-machine interface.

The emergent surface of the healing element can be asymmetrical with respect to at least one median plane perpendicular to the emergent surface and passing through the center of the emergent surface or comprising a central axis of the healing element.

The healing element can comprises an anti-rotation element, in particular a portion of hexagonal cross section, for cooperating with an anti-rotation element of the implant, in particular an opening of hexagonal cross section, and for ensuring fixation of the healing element in a single orientation, without rotation about the implant.

Those parts of the emergent surface of the healing element that are intended for a positioning oriented toward the inside and outside, respectively, of the mouth can have a different shape.

A section transverse to the side surface of the healing element or a projection on a parallel plane of the emergent surface of the healing element can have:
a substantially trapezoidal shape or a substantially polygonal or triangular or square or rectangular or ovoid shape, or a substantially polygonal shape with rounded corners; and/or
a part intended for a positioning oriented toward the outside of the mouth, of larger dimension than a part intended for a positioning oriented toward the inside.

The end surface or the emergent surface of the healing element or the screw can comprise an indicator for indicating its height, or the healing element or the screw can comprise a color for indicating its height or a laser marking and/or one or more barcodes and/or data matrix codes for indicating its height.

The dental restoration method or the method for producing a restoration abutment can comprise a step of selecting a healing element from a series of at least two one-piece healing elements of different shapes, suitable for fixing to the same dental implant.

The invention also relates to a method for producing a dental restoration abutment intended to be fixed to a dental implant at a first end and to receive a prosthesis at its second end, comprising the implementation of a dental restoration method as defined above and a step of producing a restoration abutment and/or a prosthesis.

The invention also relates to a healing element. In particular, it relates to a healing element permitting the implementation of the dental restoration method and/or the method for producing an abutment as described above.

The invention is more precisely defined by the claims.

These aims, features and advantages of the present invention will be explained in detail in the following description of a particular non-limiting embodiment, with reference to the accompanying figures, in which:

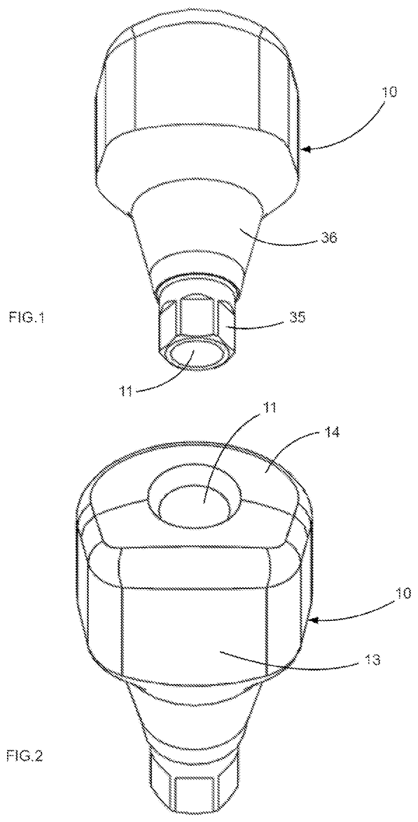

FIGS. 1 and 2 show perspective views, respectively from below and from above, of a healing element used in a restoration method according to an embodiment of the invention.

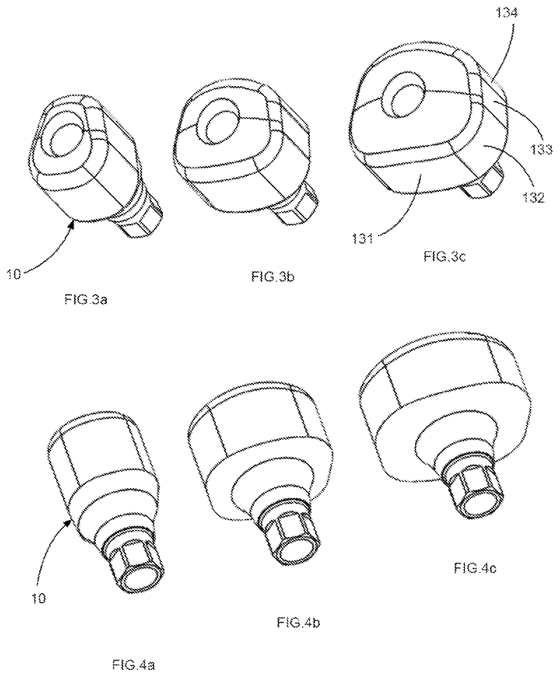

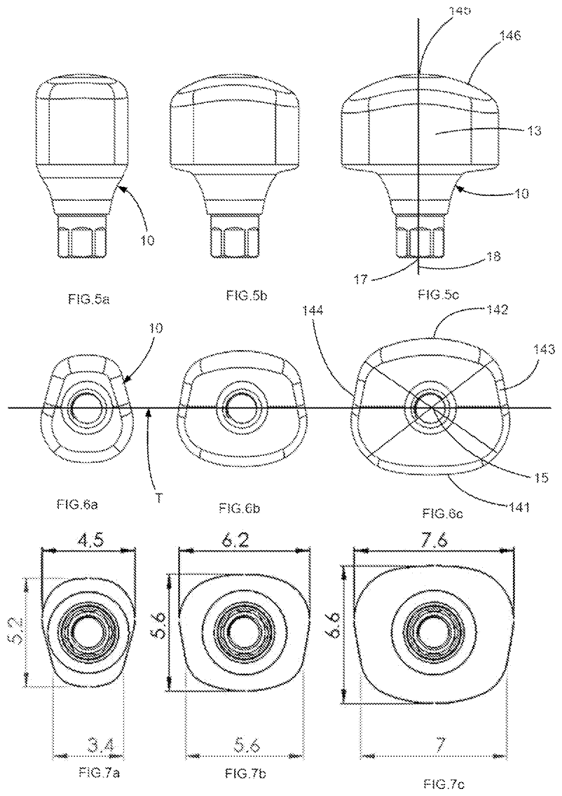

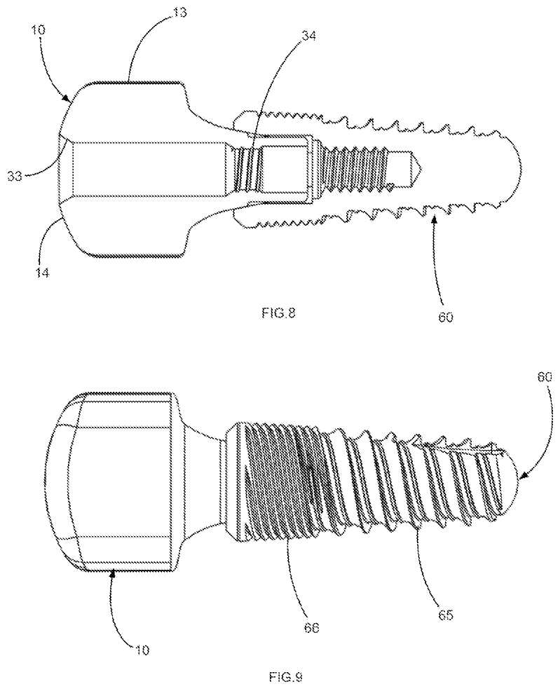

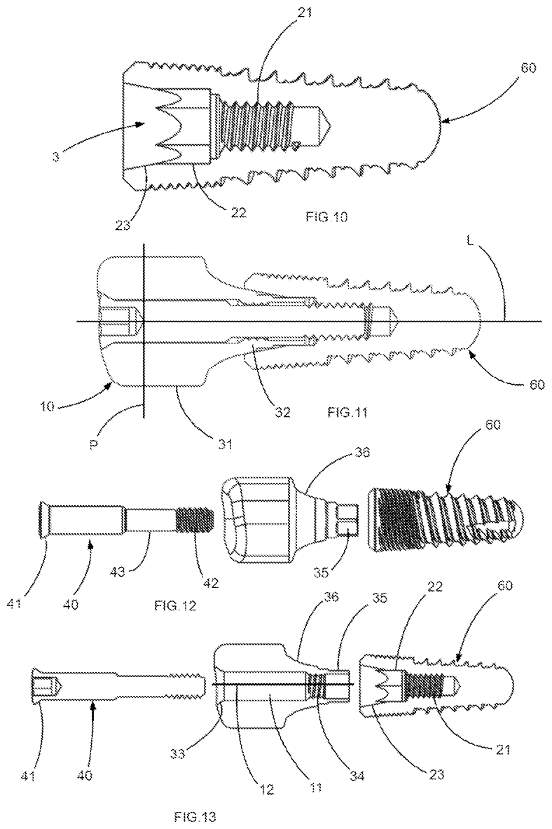

FIGS. 3a to 3c and 4a to 4c show perspective views, respectively from above and from below, of a series of healing components used in a restoration method according to an embodiment of the invention.

FIGS. 5a to 5c, 6a to 6c and 7a to 7c show side views, plan views and bottom views, respectively, of a series of healing elements.

FIG. 8 illustrates a sectional view of a healing element arranged in an implant.

FIG. 9 illustrates a side view of a healing element arranged in an implant.

FIG. 10 shows a sectional view of an implant.

FIG. 11 illustrates a sectional view of a healing element fixed on an implant by a screw.

FIGS. 12 and 13 show a side view and a sectional view, respectively, of an intermediate phase of combining an implant with a healing element and with a screw in a restoration method according to the embodiment of the invention.

FIG. 14 illustrates a sectional view of a healing assembly comprising a healing element surrounded by the gum and fixed in an implant.

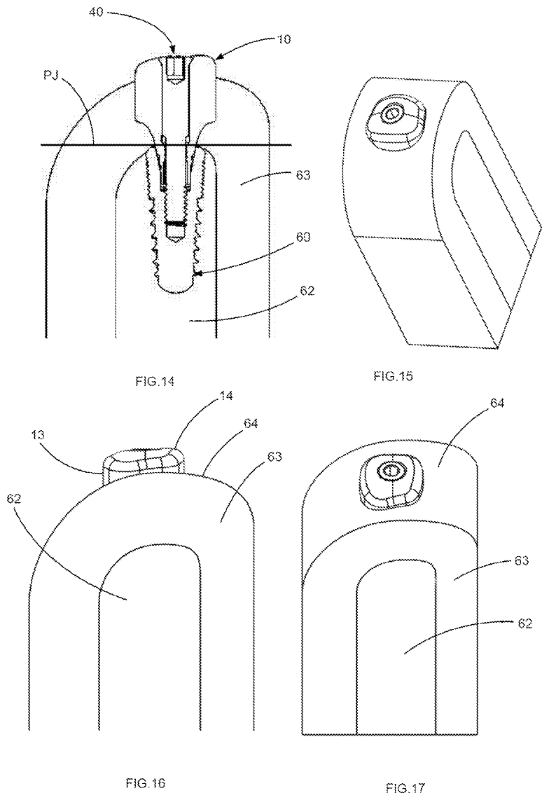

FIGS. 15, 16 and 17 show two schematic sectional views of a gum within which a healing element is fixed.

FIG. 18 shows the lower and upper teeth in a plan view.

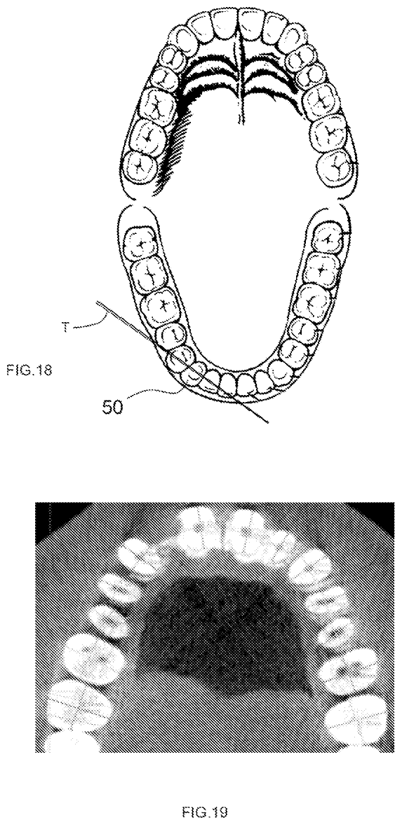

FIG. 19 shows a view of the teeth according to a juxta-gingival section.

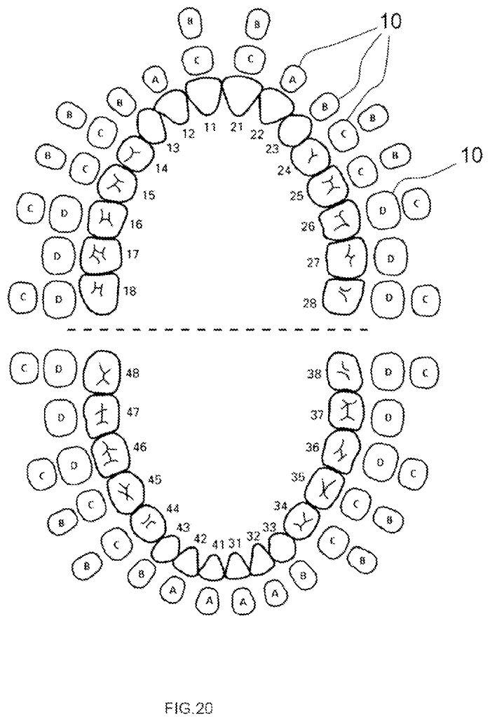

FIG. 20 shows a horizontal section of the dentition at the juxta-gingival level and the corresponding healing elements used according to the embodiment of the invention.

FIGS. 21 to 23 show sectional views through a vertical median plane illustrating steps of the restoration method according to an embodiment of the invention.

To simplify the description, a horizontal direction is defined here as any direction in a horizontal plane defined as a plane parallel to the juxta-gingival plane. The horizontal plane of a component outside the mouth of a user will be defined as a plane intended to be positioned parallel to the juxta-gingival plane after positioning in the mouth. Accordingly, the vertical direction is defined as the direction perpendicular to a horizontal plane, in accordance with which the height of a component will be measured. This perpendicular direction corresponds generally to the axis of an implant.

The restoration method according to the embodiment of the invention thus comprises two phases, as explained above: a first phase called a healing phase, during which one or more implants 60 are integrated in a bone structure 62 of the patient by osseointegration, and during which a one-piece healing element 10 is used, as will be explained in detail hereinbelow, then a second phase, being the restoration phase itself, during which a final prosthesis is placed on the one or more implants 60 by way of a restoration abutment.

As is illustrated in FIGS. 8 to 14, the implant 60 comprises an overall envelope of cylindrical or frustoconical shape and a longitudinal axis L forming an axis of revolution of this overall envelope. The implant 60 comprises a means of anchoring in the bone structure of the patient. This anchoring means can be a set of threads arranged on an outer periphery of the implant and comprising a variable thread pitch. A lower part 65 of the implant, that is to say a part of the implant deep within the bone structure 62, can comprise wider threads, while an upper part 66 of the implant, that is to say a part of the implant at the surface of the bone structure, can comprise finer threads. The implant comprises an opening at its upper end and along the longitudinal axis L, within which opening there is a connection device 3 for connecting to the healing element 10. The connection device 3 comprises a threaded opening 21, an opening 22 of hexagonal cross section in the continuation of the threaded opening, and a conical bearing surface 23 opening out on an upper face of the implant. The threaded opening 21, the opening 22 of hexagonal cross section and the conical bearing surface 23 are adjacent, coaxial to the longitudinal axis L and arranged in such a way that the threaded opening 21 is at the lower side of the implant 10, the conical bearing surface 23 is at the upper side of the implant 10, and the opening 22 of hexagonal cross section is between the threaded opening 21 and the conical bearing surface 23.

The healing element 10 is in one piece, that is to say it consists of a single piece and is preferably made from a single material. As is illustrated in FIGS. 11 to 13, the healing element 10 comprises an upper part 31 intended to be in contact with the gum 63, and a lower part 32 intended to be introduced into the opening of the implant in order to cooperate with the connection device 3. The healing element comprises a through-opening 11 oriented along an axis 12 and intended to receive a screw 40 screwed into the threaded opening 21 of the implant. The healing element is thus intended to be fixed on the implant by way of the screw 40. When the healing element is fixed on the implant, the axis 12 of the through-opening is coincident with the longitudinal axis L of the implant. This assembly is illustrated in particular by FIGS. 11 and 14. The through-opening 11 is generally cylindrical in shape and comprises, at one end at the upper part, a conical bearing surface 33. This conical bearing surface 33 is intended to cooperate with a conical bearing surface of a screw head 41 of complementary shape in such a way as to form a sealed interface. The conical bearing surface 33 and the screw head 41 thus have a function of a sealing cone.

The healing element 10 comprises at least one thread 34 arranged at the opening 11 and able to cooperate with a threaded part 42 of the screw 40 in order to prevent separation of the screw 40 and the healing element 10 by a simple translational movement. The screw 40 comprises an unthreaded cylindrical part 43 between the threaded part 42 and the screw head 41. The threaded part 42 is intended to cooperate with the threaded opening 21 of the implant in order to block the healing element in position. The cylindrical part 43 of the screw is intended to be positioned along the opening 11 of the healing element. When joining the screw 40 to the healing element 10, the screw has to be screwed through the at least one thread 34. The screw is designed in such a way that, when the screw head 41 rests on the conical bearing surface 33 of the healing element, the at least one thread 34 lies opposite the cylindrical part 43 of the screw. Advantageously, the threaded part 42 of the screw 40 cannot simultaneously be in engagement with the at least one thread 34 and the threaded opening 21 of the implant. Such an assembly of the screw, also called a “captive” assembly, avoids mistakenly separating a healing element from the screw associated with it; for example, this assembly makes it possible to avoid dropping the screw while manipulating the healing element. The healing element and the screw can thus be supplied in pre-assembled form, which reduces the number of manipulations performed by the dentist. In addition, the at least one thread 34 also constitutes an attachment point of the healing element and will be able to be used during a subsequent withdrawal of the healing element. Indeed, the dentist can then partially unscrew the screw in order to separate its threaded part 42 from the threaded opening 21 of the implant, while keeping the threaded part 42 engaged on the at least one thread 34 of the healing element. The dentist can then easily grasp the screw head and pull upward to remove the healing element without transmitting stress to the implant and without causing discomfort to the patient.

At its lower end and on an outer periphery, the healing element 10 comprises a portion 35 of hexagonal cross section, suitable for cooperating with the opening 22 of hexagonal cross section of the implant. The interface thus formed makes it possible to guarantee fixation of the healing element 10 in a single orientation, without rotation of the healing element about the implant 60. The portion 35 of hexagonal cross section and the opening 22 of hexagonal cross section are anti-rotation elements that could be replaced by any other equivalent anti-rotation elements. The healing element thus comprises at its lower end a device for fixing to an implant. In addition, the healing element also comprises, on the outer periphery of its lower part 32, a frustoconical or substantially frustoconical portion 36 able to cooperate with the conical bearing surface 23 of the implant in order to form a sealed interface between the implant and the healing element. The frustoconical portion 36 comprises a boundary between lower part 32 and the upper part 31 of the healing element. The conical bearing surface 23 and the frustoconical portion 36 have a sealing cone function and also a function of unique positioning of the healing element with respect to the implant. The assembly of the conical bearing surface 23 to the frustoconical portion 36 in fact constitutes a pivot joint with an axis coincident with the longitudinal axis L. In particular, after tightening of the screw 40, such a connection reduces to zero any translational play between the healing element and the implant along the longitudinal axis L or any axis perpendicular to the longitudinal axis L. Moreover, as a rotation of the healing element with respect to the implant is impossible by virtue of the interface formed by the portion 35 of hexagonal cross section and the opening 22 of hexagonal cross section, the connection between the healing element and the implant is a particularly rigid connection.

The upper part of the healing element comprises an end face 14 through which opens the conical bearing surface 33 of the opening 11, and a side surface 13 about which the gum 63 is intended to heal. The conical bearing surface is oriented toward the inside of the healing element such that the screw head 41 is embedded in the healing element. Thus, the screw head 41 does not protrude from the end face 14.

Existing implants can have different shapes and in particular three different connection devices. There can be as many different healing elements as there are different connection devices, so as to be able to provide, for each existing implant, a healing element that is equipped with a connection device adapted to it.

The healing element 10 has the function of lodging itself within the incised gum, after fixation of an implant. The final configuration is shown in FIG. 14. In this configuration, the implant 60 is rigidly connected to the bone structure 62 and slightly emerges from the bone part in the gum 63. The healing element 10 is fixed to the implant 60 in such a way that the gum 63 is almost exclusively in contact with the healing element 10. The healing element participates temporarily in the restoration method, permitting the healing and the smooth production of the final prosthesis, as will be explained in detailed hereinbelow.

The gum 63 thus heals around the side surface 13 of the healing element 10. For this purpose, this side surface 13 is chosen to optimally match the oral environment presented by the patient. The end surface 14 of the healing element is intended to remain visible above the gingival surface 64 of the gum 63, since the gum remains fully in contact with the side surface 13 of the healing element. It will be noted that the upper part of the side surface 13 and the end surface 14 thus form an emergent surface of the healing element. This emergent surface is illustrated in particular by FIGS. 15 to 17. For this purpose, healing elements of different height can be provided in order to adapt to different configurations of the oral geometry. By way of example, three different standard heights permit good adaptation to all situations. This height is advantageously between 3 and 7 mm. Coloring of the screw can make it possible to rapidly identify the height of the healing element. For example, a blue screw can be associated with the small healing element. A green screw can be associated with the healing element of intermediate size. A red screw can be associated with the large healing element. Thus, the dialogue between dentists and prosthetists can be simplified.

According to the embodiment of the invention, the shape of the healing element is specifically chosen to promote the healing of the gum according to an anatomical shape corresponding optimally to the tooth to be replaced and therefore also to the future prosthesis that is intended to occupy this oral space. This shape is characterized in particular by the flat section of its side surface 13, this section being a transverse section through a plane P perpendicular to the side surface 13, shown in FIG. 11, and substantially parallel to the end surface 14. It will be noted that this section is substantially reproduced by the shape of the end surface 14, or more precisely by the projection of this end surface 14 on such a perpendicular plane, that is to say substantially parallel to the gingival surface 64.

To understand the approach used, FIG. 18 illustrates a plan view of the upper and lower teeth, and FIG. 19 illustrates a sectional view of the juxta-gingival plane PJ of a dentition, shown in FIG. 14, at the root of emergence of the teeth. These figures show that the teeth have cross sections of different shape, which it is possible to simplify through rectangular shapes and/or square shapes and/or triangular shapes, but more precisely trapezoidal shapes.

According to the embodiment chosen, a series of healing elements 10 of different shapes will permit the best possible reproduction of these different shapes. FIG. 20 thus shows a plan view of the cross sections of all the teeth and a plan view of healing elements 10 associated with each tooth. The shapes of the different series of teeth, numbered from 11 to 18, 21 to 28, 31 to 38 and 41 to 48 in this figure (these numbers are not to be confused with the numerical references used in the other figures to designate the features of the invention), are all approached by way of four different healing elements 10, designated A to D. For some teeth, or indeed all the teeth, several healing elements from among the healing elements A to D appear suitable.

In the illustrative embodiment chosen and shown in FIG. 20, the healing elements A are adapted for restoration of the upper lateral incisors and all the lower incisors. The healing elements B are adapted for restoration of the canines and premolars, the healing elements C are adapted for restoration of the intermediate molars, and the healing elements D are adapted for restoration of the largest molars. Alternatively, the series of healing elements 10 could comprise another number of different healing elements, for example three or five different healing elements.

These healing elements will now be described in more detail by considering a series of three healing elements A, B and C. The healing element A is illustrated particularly in FIGS. 3a to 7a, the healing element B in FIGS. 3b to 7b, and the healing element C in FIGS. 3c to 7c. To avoid overcomplicating the figures, the numerical references are not reproduced on all the healing elements of these figures. However, all of these healing elements have the same characteristics, as will be described.

As will be seen from FIGS. 3 and 6, the end surfaces 14 of these healing elements 10 (A to C), intended for positioning above the gingival emergence, are substantially plane and intended for a positioning parallel to a horizontal plane (parallel to the juxta-gingival plane PJ, between 1 and 2 mm inclusive above this plane) corresponding to the sectional plane of FIG. 18. However, they are slightly curved, having a central part 145, seen more particularly in FIGS. 5a to 5c, intended to rise further above the gum than its peripheral parts 146.

The transverse section of the healing element, through a plane P perpendicular to its side surface 13 as explained above, which gives the final shape to the gum after healing, is substantially reproduced by the end surface 14 of the healing element, which lies in its continuation. The cross sections of all the healing elements all have a substantially trapezoidal shape. They have a long side 141, which will be arranged on the side toward the outside of the mouth (vestibular aspect), a short side 142 parallel and opposite thereto, which will be arranged on the side toward the inside of the mouth (lingual aspect), which are connected by two sides 143, 144. The intersection of the diagonals of the trapezium allows a center 15 to be defined. Moreover, considering the center 17 of the substantially circular opening 11 of the healing element 10 at its lower end, it is possible to define a central axis 18 of the healing element passing through the two central points 15, 17. This axis 18 of the healing element 10 is perpendicular to the end surface 14. The axis 18 is also coincident with the axis of the opening 11 and the longitudinal axis L of the implant.

The three types of healing elements 10 (A, B and C) therefore differ in particular in terms of the trapezoidal shape of the cross section of their side surfaces 13. Depending on the healing element in question, the trapezoidal shape can come close to a triangular shape or a rectangular shape, or even a square shape. By way of example, FIGS. 7a to 7c give orders of magnitude of the dimensions of these healing elements, in millimeters.

Of course, this substantially trapezoidal shape has rounded corners and curved sides, so as to ensure that it does not damage the gum. Moreover, the end surface 14 of each healing element has, except for the opening 11, a continuous surface without relief and/or without hollows and/or without grooves and/or without ridges and/or without roughness. This surface is convex. This geometry without roughness promotes oral hygiene and reduces the accumulation of food matter and the deposition of dental plaque.

Alternatively, the series of healing elements could comprise a different number of different geometries, for example at least two. In a simplified alternative embodiment, a single shape of healing element could be suitable for all the teeth.

According to other alternative embodiments, the transverse section of a healing element, at its side surface 13, could be similar to any polygon, such as a polygon with three, five or six sides. Alternatively, the corners of these polygons could be so rounded that the overall shape would come close to an oblong shape, even of oval cross section, or any other shape farther from a polygon. Advantageously, this shape comprises at least one center or point that is perfectly defined geometrically in order to define a center 15, or a possible axis 18 of the healing element.

According to the embodiment, the geometry of the visible emergent surface of the healing element toward the inside of the mouth differs from the geometry on the side toward the outside, so as to take account of the curvature of the gum. This shape of the emergent surface of the healing element is thus asymmetrical with respect to a median plane containing the tangent T to the gum, shown in FIGS. 6a to 6c, and more precisely in FIG. 18 in relation to a tooth 50 to be restored. This median plane, called tangent plane T, is parallel to the tangent T to the gum, perpendicular to the juxta-gingival plane PJ and passes through the middle 15 of a healing element.

Thus, a circular shape for the cross section of a healing element, associated for example with a cylindrical healing element, is unsuitable. More generally, any plane curve with symmetry about a point or axis is little suited or unsuitable for the abovementioned cross section of the healing element, since on the one hand it would not be adapted to the anatomy of the mouth and, on the other hand, its circular orientation about this axis would no longer be identifiable. For the same reasons, the emergent and visible surface of the healing element is therefore not symmetrical with respect to at least one or even several planes parallel to its axis 18, and/or comprising this axis 18. It is not symmetrical with respect to at least one or several planes perpendicular to the emergent surface and passing through its center 15, which we call perpendicular median planes. In the example shown, only the plane perpendicular to the aforementioned tangent plane T, passing through between the two sides 141, 142, forms a plane of symmetry. The preceding observations apply to the emergent surface of the healing element, or to its transverse section through a sectional plane P defined above, or to the projection of its emergent surface on such a plane P. The perpendicular median plane is then any plane perpendicular to the plane P and passing through the center of the considered geometry of the healing element. Alternatively, a perpendicular median plane can be defined as any plane containing the axis 18 of the healing element. This emergent surface of a healing element can finally take any identifiable three-dimensional shape, making it possible to recognize the healing element used and possibly to know its orientation, in order to fulfill a second function that will be discussed in detail hereinbelow.

As a complement to the previously described asymmetry, which manifests itself in a horizontal plane parallel to the juxta-gingival plane, it is advantageous if the healing element alternatively comprises a vertical asymmetry, that is to say in the direction perpendicular to the juxta-gingival plane. According to the embodiment that can be seen in particular in FIGS. 14, 16, 21 and 22, the healing element has a greater height on the lingual side in relation to its height on the opposite, vestibular side. This other asymmetry, called vertical asymmetry, also has the first advantage of offering an anatomical shape, and the second advantage of participating in the recognition of the identity and/or positioning of the healing element. In the embodiment illustrated in FIGS. 14, 16, 21 and 22, it will be noted that the upper surface of the healing element has overall an inclination with respect to a horizontal plane. This inclination is substantially constant, the section of the surface represented in FIG. 14 showing a substantially linear upper end.

The end surfaces 14 of the healing elements are continued, from their periphery 146, by the side surface 13 about which the gum heals, and which thus gives the gum shape adapted to the future prosthesis. This side surface 13 has a plurality of surfaces 131, 132, 133, 134, which are substantially plane and optionally slightly curved, extending in a direction substantially parallel to the axis 18 of the healing element and/or parallel to the longitudinal axis L of the implant, respectively continuing the various sides 141, 142, 143, 144 of the end surface 14 of the healing element. The interfaces between the end surface 14 and these different parts of the side surface 13 are formed by rounded surfaces without roughness, in particular convex surfaces.

The healing element can be made of plastic material compatible with medical use and having a pink, white or cream color. In particular, the healing element can be produced from a polymer material, in particular from a PEEK material. Alternatively, it can be made of metal, for example titanium, or can be made of zirconia. The healing element can be produced by machining and/or by molding and/or by addition of material, in other words by 3D printing.

The use of healing elements thus makes it possible to promote ideal healing of the gum in a dental restoration method, as has been discussed, due to its geometry designed in line with oral anatomy. It will be noted that this healing element can alternatively be completely subgingival and invisible, and then rendered visible by intervention on the gum in order to implement the rest of the recognition process that is described below. In this case, it will always be incorrect to call the end part of the healing element the emergent part.

Besides the advantages described above, the healing element permits the implementation of an advantageous restoration method, and of a method for producing a final dental prosthesis and a final abutment, with minimal trauma to the gum. It is in fact possible to obtain a digital or physical impression of the zone to be restored without removing the healing element from the mouth, hence without damaging the gum. Thus, in addition to its primary healing function, as detailed above, the healing element performs a second function in the restoration method, by permitting advantageous definition of the shape of the restoration abutment and/or of the prosthesis before being removed. This function complements its first healing function, since it makes it possible to avoid trauma to the gum after the latter has healed according to a selected and advantageous anatomical shape.

For this purpose, at the end of the healing phase of the dental restoration method, a practitioner can take a digital impression of the patient's mouth without removing the healing element. The digitization data, obtained by any device such as an oral scanner for example, are automatically transmitted to a computer equipped with dental restoration software. This software is equipped with a man-machine interface via which an operator can indicate the healing element model that has been used, or more generally the reference of the healing element, and possibly the implant used.

From the digitization data, software automatically determines the axis of the healing element, by geometric construction, for example from the identification of the center 15 of the healing element and the direction perpendicular to the end surface 14 passing through this center 15. By this construction, it can thus automatically determine the axis of the implant, without having to view it directly. Indeed, the healing element is advantageously aligned with the implant, its axis thus being coincident with that of the implant.

Thereafter, as the geometry of the healing element corresponds to a unique positioning about its axis 18, or about the longitudinal axis L of the implant, in order to comply with the oral environment and in particular the geometry of the gum toward the inside the mouth (lingual aspect), which differs from its geometry toward the outside (vestibular aspect), it is possible to deduce from its orientation the orientation of the implant, and in particular the connection device thereof, without having to view it directly. For example, during this construction, it is possible to specify that one of the parallel sides of the trapezoidal shape of the visible surface 14 of the healing element is parallel to one side of the hexagonal opening of the device for fixing the implant.

Finally, in the case where healing elements of different heights are present, it is necessary to determine the height so as to perfectly position the implant to be invisible. A first approach can involve forming healing elements or screws of different colors for different heights. A second approach involves arranging an indicator on the visible surface 14 of the healing element in order to indicate this height, it being possible for this indicator to be made up of numbers and/or letters and/or any symbol and/or colors and/or laser markings and/or one or more barcodes and/or data matrix codes and/or any identification code. A third approach can involve forming healing elements that have a different visible surface 14 depending on their height. For example, the healing elements A, B, C could retain the same shape but with slightly larger dimensions for greater heights, thus making it possible to differentiate them automatically and then determine their height.

In an alternative or complementary embodiment, an operator uses a man-machine interface to input the reference of the healing element, which allows the software to retrieve the characteristics of this healing element such as its height, its center and/or axis, from a library present in the form of a database stored in an electronic memory that can be consulted. FIG. 21 illustrates an example of a virtual healing element 10′ stored in the library associated with the restoration software. A landmark in the space 51′ is associated with the healing element, allowing its positioning in the space. Alternatively, the software can automatically recognize the healing element from its geometric characteristics, without manual input of its reference. An operator can assist the software to correctly position the landmark 51 of the actual healing element, that is to say the recognition of its actual positioning, by entering one or more points of the emergent surface on an image obtained by the abovementioned digitization step and presented to the operator on a screen of a man-machine interface.

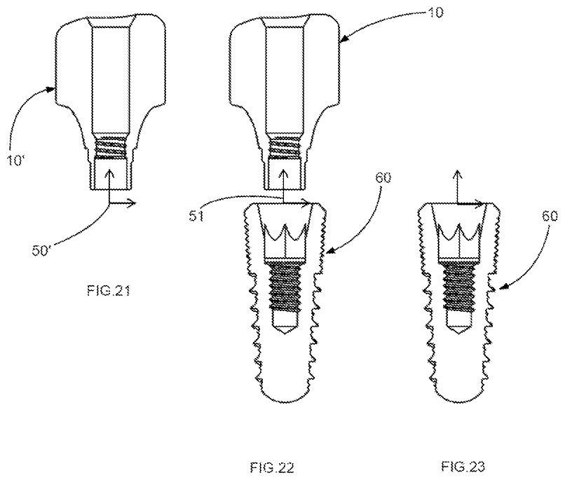

From the digitized data, and possibly with the aid of the one or more points of the surface of the healing element that are manually indicated by an operator, the software is then able to associate the virtual healing element from its library with the digitized oral environment, replacing the real healing element, in order to obtain a more perfect digital reproduction. It will be noted that the shape of the real healing element makes it possible to determine its orientation, in particular on account of its asymmetrical shape, as has been mentioned above. As has been described, this asymmetry can be simple, in a horizontal and/or vertical plane, or can be bi-asymmetrical, both horizontal and vertical. As is shown in FIG. 22, the actual landmark 51 of the healing element 10 is thus determined automatically by the software. It is possible to perfectly position the virtual healing element on the digital impression, automatically or optionally by intervention of an operator on a man-machine interface for displaying the oral impression and the healing element. This perfect positioning of the virtual healing element makes it possible to deduce therefrom all the surrounding geometries, based on the known references stored in the database associated with specific healing element in question, including the position of the implant 60 and the geometry of the healed gum without the presence of the healing element 10, as shown in FIG. 23.

When the restoration software has exactly repositioned the positioning of the hidden implant, it deducts from this knowledge the final geometry of the restoration abutment to be produced, which must be fixed to the implant and must occupy the entire gingival volume defined by the healing element, then the geometry of the dental prosthesis intended to be fixed to this abutment, in a known manner.

It will be noted that this restoration method can be carried out entirely digitally, therefore virtually, or can comprise phases of construction of a model in plastic or plaster. In the latter case, a physical impression, for example using silicone, can be taken, a plaster can be cast in the impression to create the master model, that is to say a replica of the dental arch to be restored, which is then scanned in the laboratory to reconstruct a digital image.

As will be clear from the above description, the last phase of the restoration method thus involves a restoration device, which comprises a central processing and control unit, here comprising at least one microprocessor, connected to an electronic memory, on which software is executed to allow the implementation of some or all of the steps of the restoration method described above. This central unit is linked by a communications device to a module for obtaining digital data representing all or some of a patient's dentition, which module can consist of a device such as an oral scanner. It is also linked to a man-machine interface, comprising for example a screen and/or a keyboard, in order to permit exchanges with an operator, as explained above. The central unit then performs all the necessary processing, calculating and other operations, by software. Finally, it is able to generate and transmit production commands to a device for production of a restoration abutment and/or a prosthesis. It can also be linked by a second communications device to a production device such as a machine tool.

1. A dental restoration method comprising:
determining a positioning of a dental implant, integrated in a bone structure of a mouth of an individual, from an identification and positioning of a one-piece healing element, fixed at one of its ends in the implant,
the healing element comprising
a side surface intended to be integrated within a gum in order to shape the gum during the healing of the gum, and
an end surface, a part of the side surface and of an end surface forming an emergent surface which is intended to remain outside the gum and which is asymmetrical with respect to at least one perpendicular median plane.

2. The dental restoration method as claimed in claim 1, wherein the emergent surface is asymmetrical in a horizontal and/or vertical plane.

3. The dental restoration method as claimed in claim 1, further comprising fixing the healing element on the implant a screw that cooperates with a through-opening the healing element and a threaded opening of the implant.

4. The dental restoration method as claimed in claim 3, wherein the healing element comprises a conical bearing surface cooperating with a conical portion of a head of the screw in order to seal an interface between the screw and the healing element.

5. The dental restoration method as claimed in claim 3, wherein the healing element comprises, at the through-opening of the healing element, at least one thread cooperating with a threaded part of the screw in order to prevent separation of the screw and the healing element by a simple translational movement.

6. The dental restoration method as claimed in claim 1, wherein the healing element comprises a frustoconical portion cooperating with a conical bearing surface of the implant in order to seal an interface between the implant and the healing element and to eliminate any translational play between the healing element and the implant.

7. The dental restoration method as claimed in claim 1, wherein the healing element is produced from a polymer material, from zirconium, or from titanium.

8. The dental restoration method as claimed in claim 1, wherein the healing element is produced by machining and/or by molding and/or by addition of material.

9. The dental restoration method as claimed in claim 8, wherein the determining of the positioning of the implant comprises:
taking a manual or digital impression of an oral space comprising the healing element fixed on the implant;
automatically detecting the positioning of the implant by identifying at least one of the following:
an axis of the implant corresponding to an axis of the healing element identified by a geometry of a surface of the healing element emergent from the gum or from an association with a healing element stored in a database;
an orientation of the implant from an orientation of the surface emergent from the gum or from an association with a healing element stored in a database;
height of the implant by determining a height of the healing element, from a color or an indicator of a surface of the healing element emergent from the gum or from an association with a healing element stored in a database.

10. The dental restoration method as claimed in claim 1, wherein the emergent surface of the healing element is asymmetrical with respect to at least one median plane perpendicular to the emergent surface and passing through a center of the emergent surface or comprising a central axis of the healing element.

11. The dental restoration method as claimed in claim 1, wherein the healing element comprises an anti-rotation element cooperating with an anti-rotation element of the implant and ensuring fixation of the healing element in a single orientation, without rotation relative to the implant.

12. The dental restoration method as claimed in claim 1, wherein parts of the emergent surface of the healing element that are intended for a positioning oriented toward an inside and an outside, respectively, of the mouth have a different shape.

13. The dental restoration method as claimed in claim 1, wherein a section transverse to the side surface of the healing element or a projection on a parallel plane of the emergent surface of the healing element has:
a substantially trapezoidal shape or a substantially polygonal or triangular or square or rectangular or ovoid shape, or a substantially polygonal shape with rounded corners; and/or
a part intended for a positioning oriented toward an outside of the mouth, of larger dimension than a part intended for a positioning oriented toward an inside of the mouth.

14. The dental restoration method as claimed in claim 1, wherein
the end surface for the emergent surface of the healing element or the screw comprises an indicator for indicating a height, or
the healing element or the screw comprises a color and/or a laser marking and/or one or more barcodes and/or data matrix codes for indicating a height.

15. The dental restoration method as claimed in claim 1, further comprising selecting the healing element from a series of at least two one-piece healing elements of different shapes, suitable for fixing to the same dental implant.

16. A method for producing a dental restoration abutment intended to be fixed to a dental implant at a first end and to receive a prosthesis at its second end, the method comprising:
implementing a dental restoration method as claimed in claim 1, and
producing a restoration abutment and/or a prosthesis.

17. A healing element, wherein
the healing element is in one piece, and
the healing element comprises a fixing device at one of its ends for an implant,
the healing element comprises
a side surface intended to be integrated within a gum in order to shape the gum during the healing of the latter, and
an end surface, a part of the side surface and of the end surface forming an emergent surface which is intended to remain outside the gum and which is asymmetrical with respect to at least one perpendicular median plane.

18. The healing element as claimed in claim 17, wherein the emergent surface is asymmetrical in a horizontal and/or vertical plane.

19. The healing element as claimed in claim 17, wherein the healing element comprises a through-opening for the passage of a screw, and, at the through-opening, at least one thread suitable for cooperating with a threaded part of a screw in order to prevent separation of the screw and the healing element by a simple translational movement.

20. The healing element as claimed in claim 17, which is made from a polymer material, from zirconium, or from titanium.

21. The healing element as claimed in claim 17, wherein the emergent surface of the healing element is asymmetrical in a horizontal and/or vertical plane with respect to at least one median plane perpendicular to the emergent surface and passing through the center of the emergent surface or comprising a central axis of the healing element.

22. The healing element claimed in claim 17, wherein the healing element comprises an anti-rotation element adapted for cooperating with an anti-rotation element of an implant and for ensuring fixation of the healing element in a single orientation, without rotation relative to the implant.

23. The healing element as claimed in claim 17, wherein the pans of the emergent surface of the healing element that are intended for a positioning oriented toward an inside and an outside, respectively, of a mouth of a patient have a different shape.

24. The healing element as claimed in claim 17, wherein a section transverse to the side surface of the healing element or a projection on a parallel plane of the emergent surface of the healing element has:
a substantially trapezoidal shape or a substantially polygonal or triangular or square or rectangular or ovoid shape, or a substantially polygonal shape with rounded corners; and/or
a part intended for a positioning oriented toward an outside of a mouth of a patient, of larger dimension than a part intended for a positioning oriented toward an inside of the mouth of the patient.

25. The healing element as claimed in claim 17, wherein
the end surface or the emergent surface of the healing element or of a screw positioned in the healing element comprises an indicator for indicating a height, or
the healing element or a screw positioned in the healing element comprises a color and/or a laser marking and/or one or more barcodes and/or data matrix codes for indicating a height.
